(19) United States
(12) Patent Application Publication
(10) Pub. No.: US 2021/0132438 A1
(43) Pub. Date: May 6, 2021

(54) DISPLAY APPARATUS

(71) Applicants: HannStar Display(Nanjing) Corp., Nanjing (CN); HannStar Display Corporation, Taipei City (TW)

(72) Inventor: Yen-Chung Chen, Taichung City (TW)

(73) Assignees: HannStar Display(Nanjing) Corp., Nanjing (CN); HannStar Display Corporation, Taipei City (TW)

(21) Appl. No.: 17/004,029

(22) Filed: Aug. 27, 2020

(30) Foreign Application Priority Data
Oct. 31, 2019 (CN) 201911063111.6

(51) Int. Cl. G02F 1/1335; G02F 1/13357

(52) U.S. Cl. CPC G02F 1/133555; G02F 2203/09; G02F 1/1336

(57) ABSTRACT

The invention provides a display apparatus including a reflective display and a front light source module. The front light source module is provided with a light emitting element configured to emit an illuminating beam. There is an included angle θ between an optical axis of the light emitting element and a normal line of a display surface of the reflective display, and 0°≤|θ|≤75°. The illuminating beam passes through space between the front light source module and the reflective display and is reflected by the reflective display to be converted into a display beam. The invention provides a display apparatus with low energy consumption, and even though an electronic device using the display apparatus has been used for a relatively long time, it is not necessary to frequently replace a battery or recharge the display apparatus.

### CROSS-REFERENCE TO RELATED APPLICATION

This application claims the priority benefit of China application serial no. 201911063111.6, filed on Oct. 31, 2019. The entirety of the above-mentioned patent application is hereby incorporated by reference herein and made a part of this specification.

### BACKGROUND

### Technical Field

The disclosure relates to a display apparatus, and in particular, to a display apparatus using a reflective display and a front light source module.

### Description of Related Art

Intelligent door locks have gradually become a mature security technology in recent years. Generally, they may be unlocked by using a smartphone, a smart chip, electronic cipher, or various biometric features (for example, a facial image, a fingerprint, or a palm print) that can be used to verify identities instantly without using a physical key. Comparing with conventional keys, these unlocking methods bring more convenience and advanced security. Therefore, the intelligent door locks have become popular electronic commodities. On the market, intelligent door locks in some fields having display apparatuses improve user experience. However, a conventional display apparatus has a problem of excessively high energy consumption in standby modes, and therefore, power source such as a battery needs to be frequently replaced or the conventional display apparatus needs frequently recharging. To resolve this kind of trouble when consumers using such electronic apparatuses, the invention provides a display apparatus applying a reflective display and a front light source module, which can resolve the foregoing problem.

### SUMMARY

The invention is directed to a display apparatus, and the display apparatus has an advantage of low energy consumption.

According to embodiments of the invention, the display apparatus includes a reflective display and a front light source module. The front light source module is provided with a light emitting element configured to emit an illuminating beam. There is an included angle θ between an optical axis of the light emitting element and a normal line of a display surface of the reflective display, and 0°≤|θ|≤75°. The illuminating beam passes through space between the front light source module and the reflective display and is reflected by the reflective display to be converted into a display beam.

In the display apparatus according to the embodiments of the invention, the front light source module is capable of moving relative to the reflective display.

In the display apparatus according to the embodiments of the invention, the front light source module is pivotally connected to the reflective display.

In the display apparatus according to the embodiments of the invention, the front light source module is disposed adjacent to the reflective display and is adapted to rotate toward the reflective display with a first rotation axial line as an axis.

In the display apparatus according to the embodiments of the invention, the light emitting element is adapted to rotate with a second rotation axial line as an axis.

In the display apparatus according to the embodiments of the invention, the front light source module is adjacently disposed at a first position on the reflective display and is adapted to rotate to a second position located outside the reflective display with a first rotation axial line as an axis.

In the display apparatus according to the embodiments of the invention, the front light source module further includes a light path guiding structure. The light emitting element is disposed adjacent to the light path guiding structure and is located between the light path guiding structure and the reflective display. The light path guiding structure is disposed beside the reflective display.

In the display apparatus according to the embodiments of the invention, the front light source module is slidably disposed beside the reflective display.

In the display apparatus according to the embodiments of the invention, the front light source module further includes a light path guiding structure, provided with a convex surface. The light emitting element is disposed on the convex surface of the light path guiding structure and is located between the convex surface of the light path guiding structure and the reflective display.

In the display apparatus according to the embodiments of the invention, the display apparatus further includes a casing. The reflective display is disposed inside the casing, and the light emitting element is disposed adjacent to the casing.

In the display apparatus according to the embodiments of the invention, the front light source module further includes a light path guiding structure. The illuminating beam is reflected by the light path guiding structure to be transmitted toward the reflective display.

In the display apparatus according to the embodiments of the invention, the light path guiding structure is provided with a concave surface, and the illuminating beam is reflected by the concave surface to be transmitted toward the reflective display.

In the display apparatus according to the embodiments of the invention, an area of the display surface of the reflective display is A, and an area of the reflective display that is covered by the illuminating beam is equal to or greater than 0.7A.

In the display apparatus according to the embodiments of the invention, the reflective display is one of a total reflective liquid crystal display and a transflective liquid crystal display.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a schematic front view of an electronic device 10 according to a first embodiment of the invention.

FIG. 1B is a schematic side view of the electronic device 10 according to the first embodiment of the invention.

FIG. 2 is a schematic perspective diagram of a front light source module 120 according to an embodiment of the invention.

FIG. 3A is a schematic front view of an electronic device 10A according to a second embodiment of the invention.

FIG. 3B is a schematic side view of the electronic device 10A according to the second embodiment of the invention.

FIG. 4A is a schematic front view of an electronic device 10B according to a third embodiment of the invention.

FIG. 4B is a schematic side view of the electronic device 10B according to the third embodiment of the invention.

FIG. 5A is a schematic front view of an electronic device 10C according to a fourth embodiment of the invention.

FIG. 5B is a schematic side view of the electronic device 10C according to the fourth embodiment of the invention.

FIG. 6A is a schematic front view of an electronic device 10D according to a fifth embodiment of the invention.

FIG. 6B is a schematic side view of the electronic device 10D according to the fifth embodiment of the invention.

FIG. 7A is a schematic front view of an electronic device 10E according to a sixth embodiment of the invention.

FIG. 7B is a schematic side view of the electronic device 10E according to the sixth embodiment of the invention.

FIG. 8A is a schematic front view of an electronic device 10F according to a seventh embodiment of the invention.

FIG. 8B is a schematic side view of the electronic device 10F according to the seventh embodiment of the invention.

FIG. 9A is a schematic front view of an electronic device 10G according to an eighth embodiment of the invention.

FIG. 9B is a schematic side view of the electronic device 10G according to the eighth embodiment of the invention.

### DESCRIPTION OF THE EMBODIMENTS

Reference will now be made in detail to the exemplary embodiments of the invention, and examples of the exemplary embodiments are illustrated in the accompanying drawings. Wherever possible, the same reference numerals are used in the drawings and the description to represent to the same or similar parts.

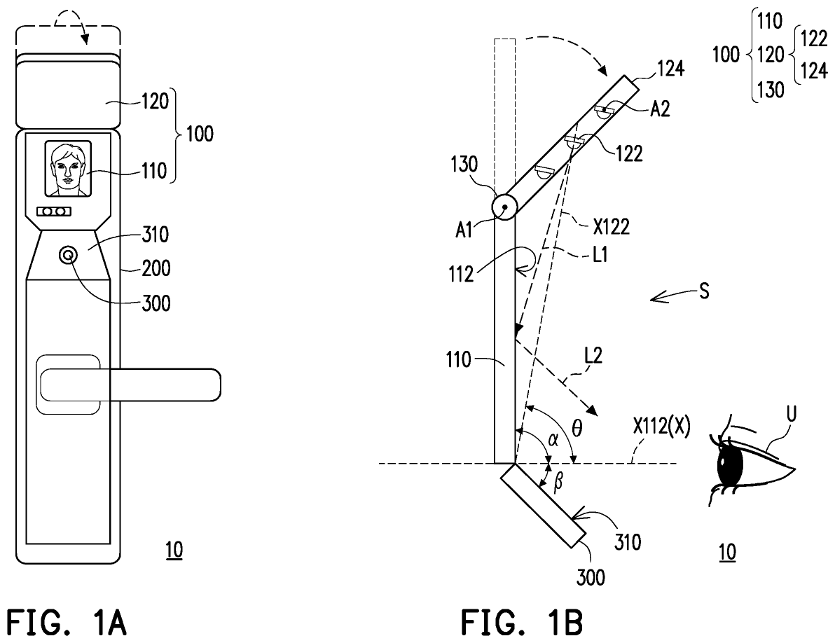

FIG. 1A is a schematic front view of an electronic device 10 according to a first embodiment of the invention. FIG. 1B is a schematic side view of the electronic device 10 according to the first embodiment of the invention. A housing 200 in FIG. 1A is omitted in FIG. 1B.

Referring to FIG. 1A and FIG. 1B, a display apparatus 100 may be applied to the electronic device 10. For example, in the present embodiment, the electronic device 10 may be an intelligent door lock, and the display apparatus 100 may be a display mounted in the housing 200 of the intelligent door lock. In the present embodiment, the electronic device 10 may further include an image capturing element 300. The intelligent door lock may determine, according to an image (for example, a facial image) captured by the image capturing element 300, whether to unlock or perform another action, and the display apparatus 100 may display a corresponding picture (the picture is, for example, but not limited to, a picture taken by the image capturing element 300). However, the invention is not limited thereto. According to other embodiments, the display apparatus 100 may also be applied to an electronic device of another type.

The display apparatus 100 includes a reflective display 110 and a front light source module 120. The front light source module 120 is disposed outside the reflective display 110. The front light source module 120 is configured to illuminate the reflective display 110 from the front of the reflective display 110. In other words, when the front light source module 120 illuminates the reflective display 110, at least a part of the front light source module 120 and a user U are located on a same side (for example, the right side of a display surface 112 in FIG. 1B) of the display surface 112 of the reflective display 110.

The front light source module 120 includes a light emitting element 122. The light emitting element 122 is configured to emit an illuminating beam L1. The illuminating beam L1 passes through space S between the front light source module 120 and the reflective display 110 and is reflected by the reflective display 110, to be converted into a display beam L2. In this way, the display apparatus 100 can display the picture.

The light emitting element 122 has an optical axis X122. Light distribution of the illuminating beam L1 emitted by the light emitting element 122 is symmetrical to the optical axis X122. For example, in the present embodiment, the light emitting element 122 includes a light emitting diode wafer, and the optical axis X122 may be an imaginary line that passes through a center of an active layer of the light emitting diode wafer and is perpendicular to a plane in which the active layer is located. There is an included angle θ between the optical axis X122 of the light emitting element 122 and a normal line X112 of the display surface 112 of the reflective display 110, and 0°≤|θ|≤75°. If an absolute value of the included angle θ exceeds 75°, it is not conducive to volume reduction of the front light source module 120, and it is easy to cause a part of display area of the display surface 112 to be an inactive area for the user U. For example, in the present embodiment, the included angle θ between the optical axis X122 of the light emitting element 122 and the normal line X112 of the display surface 112 may fall within a range from 45° to 75°, and the invention is not limited thereto. In other embodiments, the included angle θ may alternatively fall within a range from 0° to −75°. In addition, the light emitting element 122 of the invention is not limited to a light emitting diode.

In the present embodiment, the front light source module 120 is capable of moving relative to the reflective display 110, to adjust the included angle θ between the optical axis X122 of the light emitting element 122 and the normal line X112 of the display surface 112. In this way, the display apparatus 100 can provide a better display quality. For example, in the present embodiment, the front light source module 120 is pivotally connected to the reflective display 110. The front light source module 120 may rotate with a first rotation axial line A1 as an axis by using a pivoting member 130. In this way, the included angle θ between the optical axis X122 of the light emitting element 122 and the normal line X112 of the display surface 112 can be adjusted, to enable the user U to see a better display picture.

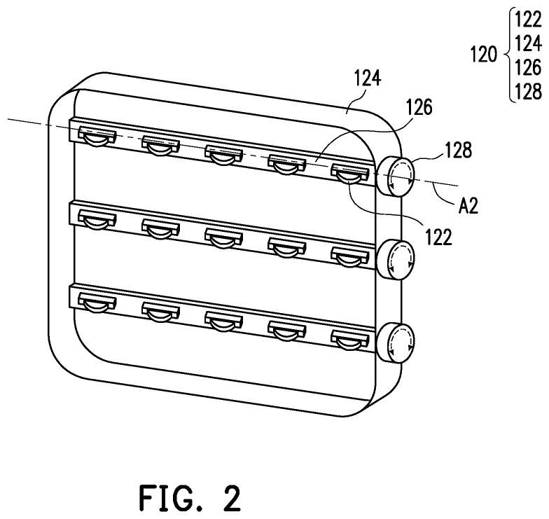

FIG. 2 is a schematic perspective diagram of a front light source module 120 according to an embodiment of the invention. Referring to FIG. 1B and FIG. 2, in the present embodiment, in addition to the light emitting element 122, the front light source module 120 may further include a first support member 124 and a plurality of second support members 126. The plurality of second support members 126 are rotatably disposed in the first support member 124, and a plurality of light emitting elements 122 is disposed on each of the second support members 126. The plurality of light emitting elements 122 may rotate with a second rotation axial line A2 as an axis by using the second support member 126. In this way, the included angle θ between the optical axis X122 of the light emitting element 122 and the normal line X112 of the display surface 112 can be adjusted more subtly, to enable the user U to see a better display picture. For example, in the present embodiment, the user U may manually rotate a knob 128 connected to the second support member 126, to adjust the included angle θ between the optical axis X122 of the light emitting element 122 and the normal line X112 of the display surface 112. However, the invention is not limited thereto. According to other embodiments, the included angle θ between the optical axis X122 of the light emitting element 122 and the normal line X112 of the display surface 112 may alternatively be automatically or semi-automatically adjusted through electronic control or computer control.

Referring to FIG. 1B, in the present embodiment, the front light source module 120 is disposed adjacent to the reflective display 110, and is configured to rotate toward the reflective display 110 with the first rotation axial line A1 as an axis. In other words, in the present embodiment, when the user U does not need to use the display apparatus 100, the front light source module 120 is optionally disposed beside the reflective display 110, or the front light source module 120 is accommodated in the housing 200. When the user U intends to use the display apparatus 100, the front light source module 120 is caused to rotate toward the reflective display 110 with the first rotation axial line A1 as an axis, to illuminate the reflective display 110.

In the present embodiment, the reflective display 110 may be a total reflective liquid crystal display. However, the invention is not limited thereto. According to other embodiments, the reflective display 110 may alternatively be a transflective liquid crystal display, or a reflective display of another type with a non-liquid crystal display medium.

In addition, in the present embodiment, the image capturing element 300 is provided with a light receiving surface 310 facing the user U. There is an included angle α between the display surface 112 of the reflective display 110 and a horizontal line X, there is an included angle β between the light receiving surface 310 of the image capturing element 300 and the horizontal line X, and α≥β, thereby helping achieve a preferable display quality. However, the invention is not limited thereto.

It should be noted herein that the following embodiments continue to use reference numerals and partial content in the foregoing embodiment, where same reference numerals are used to represent same or similar elements, and descriptions of same technical content are omitted. For descriptions of the omitted parts, refer to the foregoing embodiment, and descriptions are not repeated again in the following embodiments.

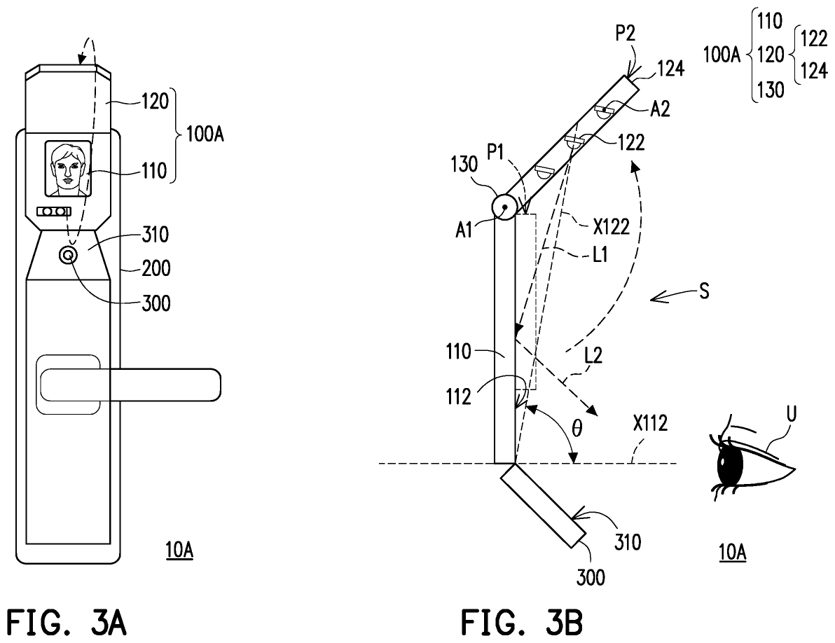

FIG. 3A is a schematic front view of an electronic device 10A according to a second embodiment of the invention. FIG. 3B is a schematic side view of the electronic device 10A according to the second embodiment of the invention. A housing 200 in FIG. 3A is omitted in FIG. 3B.

Referring to FIG. 3A and FIG. 3B, a display apparatus 100A in the present embodiment is similar to the foregoing display apparatus 100. A difference between the display apparatus 100A and the display apparatus 100 lies in that: in the present embodiment, the front light source module 120 is disposed adjacent to a first position P1 on the reflective display 110 and is configured to rotate to a second position P2 located outside the reflective display 110 with a first rotation axial line A1 as an axis. In other words, when the display apparatus 100A does not need to be used, the front light source module 120 optionally covers the display surface 112 of the reflective display 110; and when a user U intends to use the display apparatus 100A, the front light source module 120 is caused to rotate in a direction away from the display surface 112 of the reflective display 110 with the first rotation axial line A1 as an axis, to illuminate the reflective display 110.

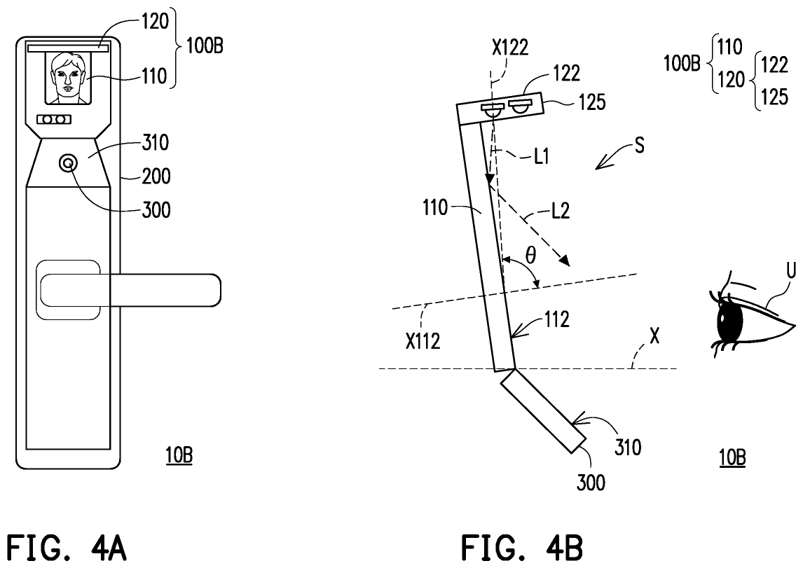

FIG. 4A is a schematic front view of an electronic device 10B according to a third embodiment of the invention. FIG. 4B is a schematic side view of the electronic device 10B according to the third embodiment of the invention. A housing 200 in FIG. 4A is omitted in FIG. 4B.

Referring to FIG. 4A and FIG. 4B, a display apparatus 100B in the present embodiment is similar to the foregoing display apparatus 100. A difference between the display apparatus 100B and the display apparatus 100 lies in that: in the present embodiment, the front light source module 120 includes a light path guiding structure 125 disposed beside the reflective display 110, the light emitting element 122 is disposed adjacent to the light path guiding structure 125 and is located between the light path guiding structure 125 and the reflective display 110, and the light path guiding structure 125 may be optionally in a fixed form. In addition, in the present embodiment, the normal line X112 of the display surface 112 of the reflective display 110 may not be parallel to a horizontal line X, that is, the reflective display 110 may be inclined.

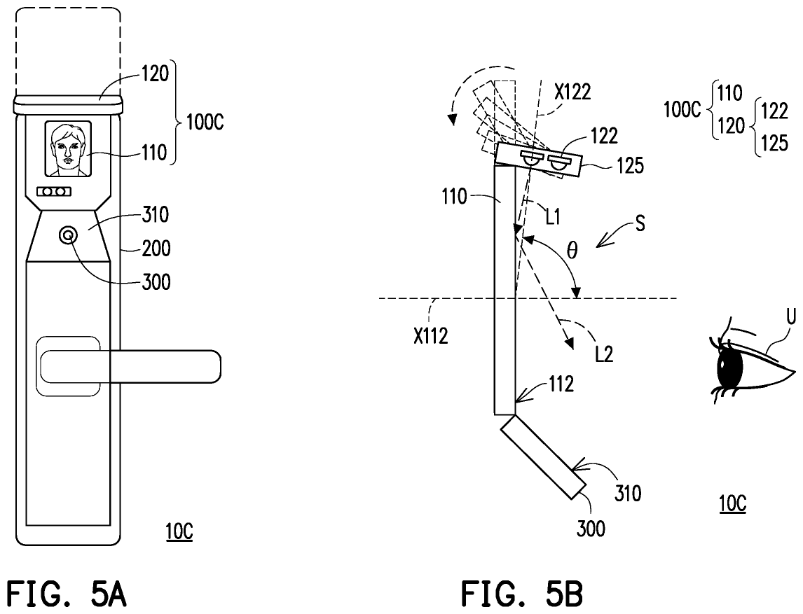

FIG. 5A is a schematic front view of an electronic device 10C according to a fourth embodiment of the invention. FIG. 5B is a schematic side view of the electronic device 10C according to the fourth embodiment of the invention. A housing 200 in FIG. 5A is omitted in FIG. 5B.

Referring to FIG. 5A and FIG. 5B, a display apparatus 100C in the present embodiment is similar to the foregoing display apparatus 100B. A difference between the display apparatus 100C and the display apparatus 100B lies in that: in the present embodiment, the front light source module 120 is slidably disposed beside the reflective display 110, for example, above the reflective display 110, rather than being fixed.

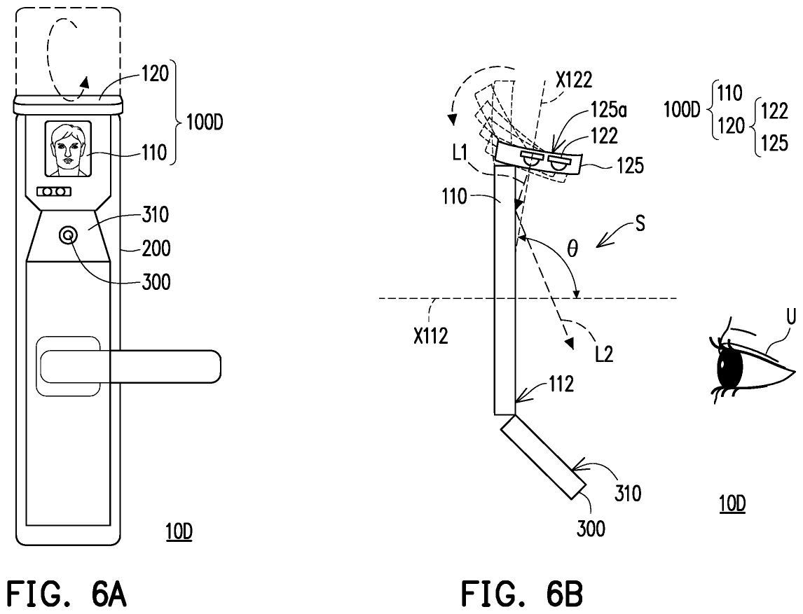

FIG. 6A is a schematic front view of an electronic device 10D according to a fifth embodiment of the invention. FIG. 6B is a schematic side view of the electronic device 10D according to the fifth embodiment of the invention. A housing 200 in FIG. 6A is omitted in FIG. 6B.

Referring to FIG. 6A and FIG. 6B, a display apparatus 100D in the present embodiment is similar to the foregoing display apparatus 100C. A difference between the display apparatus 100D and the display apparatus 100C lies in that: in the present embodiment, a light path guiding structure 125 of the front light source module 120 is provided with a convex surface 125a; and the light emitting element 122 is disposed on the convex surface 125a of the light path guiding structure 125, and is located between the convex surface 125a of the light path guiding structure 125 and the reflective display 110. The convex surface 125a of the light path guiding structure 125 is a reflective surface, and may uniformly disperse the illuminating beam L1 onto each area of the display surface 112 of the reflective display 110 by using a reflection effect of the convex surface 125a, thereby improving a better display quality.

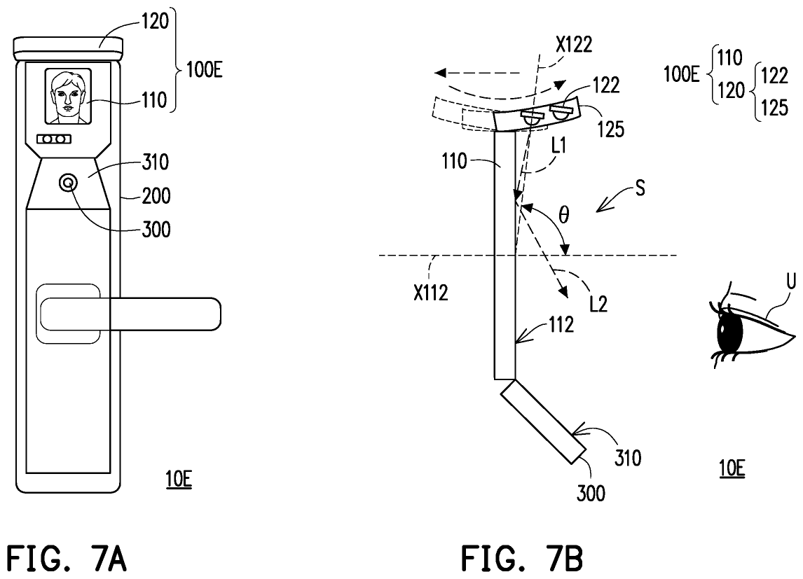

FIG. 7A is a schematic front view of an electronic device 10E according to a sixth embodiment of the invention. FIG. 7B is a schematic side view of the electronic device 10E according to the sixth embodiment of the invention. A housing 200 in FIG. 7A is omitted in FIG. 7B.

Referring to FIG. 7A and FIG. 7B, a display apparatus 100E in the present embodiment is similar to the foregoing display apparatus 100D. A difference between the display apparatus 100E and the display apparatus 100D lies in that: an action track of the front light source module 120 of the display apparatus 100E is different from that of the front light source module 120 of the display apparatus 100D. Referring to FIG. 6B, in the embodiment of FIG. 6B, the front light source module 120 may approximately slide out from a side edge of the reflective display 110 to the lower right side, and it may be understood as follows: The front light source module 120 that is originally located above the reflective display 110, when in use, slides out downward and forward from an original position, to provide a user U with the illuminating beam L1 to illuminate the reflective display 110. Referring to FIG. 7A and FIG. 7B, in the present embodiment, when the display apparatus 100E does not need to be used, the front light source module 120 may be accommodated inside the housing 200 of the electronic device 10E or be accommodated at a back surface of the reflective display 110 in a hidden manner; on the other hand, when the display apparatus 100E needs to be used, the front light source module 120 may be pressed toward the inside of the electronic device 10E, so that the front light source module 120 slides from inside the housing 200 to the outside of the housing 200, to illuminate the reflective display 110. In the present embodiment, it is not limited to pressing the front light source module 120 to enable the front light source module 120 to slide out. The front light source module 120 may be alternatively enabled to move by using a non-contact or other sensing means. The invention is not limited thereto.

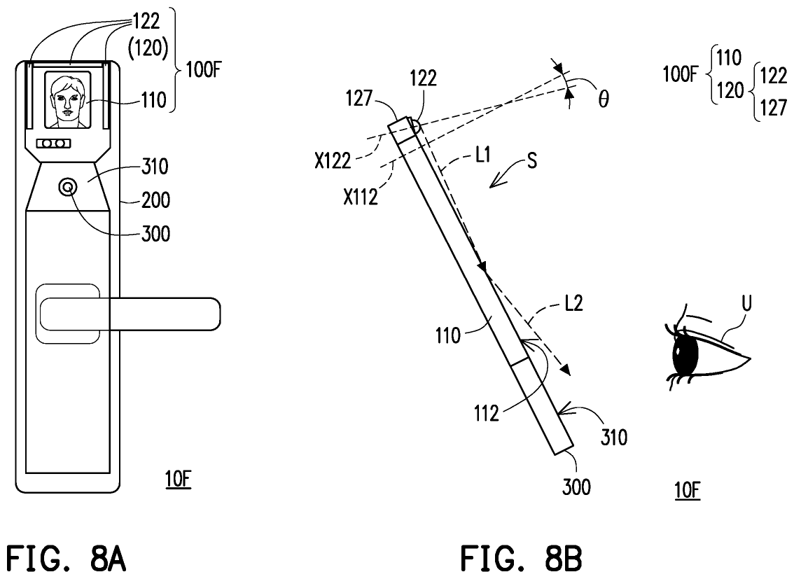

FIG. 8A is a schematic front view of an electronic device 10F according to a seventh embodiment of the invention. FIG. 8B is a schematic side view of the electronic device 10F according to the seventh embodiment of the invention. A housing 200 in FIG. 8A is omitted in FIG. 8B.

Referring to FIG. 8A and FIG. 8B, a display apparatus 100F in the present embodiment is similar to the foregoing display apparatus 100. A difference between the display apparatus 100F and the display apparatus 100 lies in that: in the present embodiment, the front light source module 120 of the display apparatus 100F further includes a casing 127. The reflective display 110 is disposed inside the casing 127. The casing 127 is disposed along at least one side edge of the reflective display 110, and the light emitting element 122 is disposed adjacent to the casing 127. For example, in the present embodiment, at least a part of the light emitting element 122 may be embedded in the casing 127. In addition, in the present embodiment, the included angle θ between the optical axis X122 of the light emitting element 122 and the normal line X112 of the display surface 112 of the reflective display 110 is greater than 0°. In other words, the optical axis X122 of the light emitting element 122 may be inclined relative to the normal line X112 of the display surface 112, to enable the illuminating beam L1 to illuminate the reflective display 110.

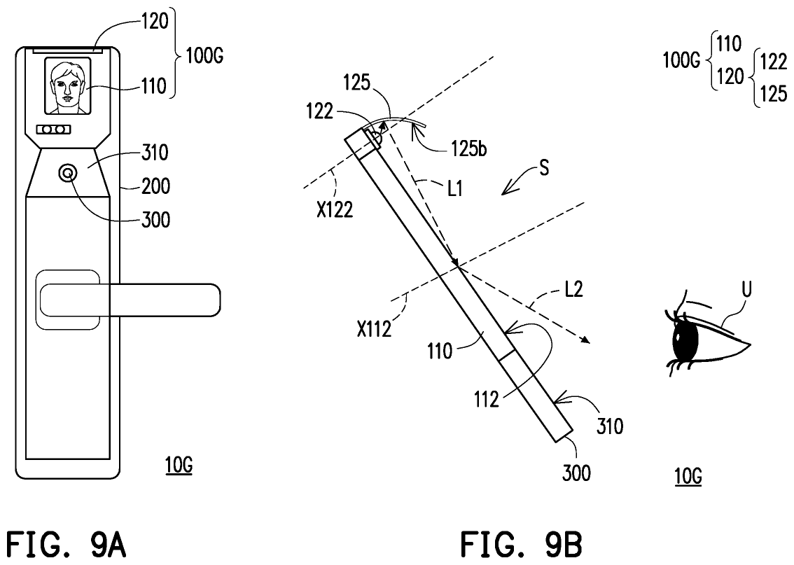

FIG. 9A is a schematic front view of an electronic device 10G according to an eighth embodiment of the invention. FIG. 9B is a schematic side view of the electronic device 10G according to the eighth embodiment of the invention. A housing 200 in FIG. 9A is omitted in FIG. 9B.

Referring to FIG. 9A and FIG. 9B, a display apparatus 100G in the present embodiment is similar to the foregoing display apparatus 100F. A difference between the display apparatus 100G and the display apparatus 100F lies in that: in the present embodiment, the front light source module 120 of the display apparatus 100G further includes a light path guiding structure 125, and the illuminating beam L1 is reflected by the light path guiding structure 125 to be transmitted toward the reflective display 110. Further, the light path guiding structure 125 may be provided with a concave surface 125b. The illuminating beam L1 is reflected by the concave surface 125b to be transmitted toward the reflective display 110.

In addition, in the listed embodiments mentioned in the invention, an area of the display surface 112 of the reflective display 110 is A, and an area of the reflective display 110 that is covered by the illuminating beam L1 is equal to or greater than 0.7A, so that an imaging effect of the display surface 112 is not excessively low and a used area of the display surface 112 is not excessively small. In other words, the illuminating beam L1 forms a flare on the reflective display 110. The flare has an area A′, and (A′/A)≥0.7. However, in other embodiments, if the reflective display 110 has a relatively large size, the area of the reflective display 110 that is covered by the illuminating beam L1 may be alternatively equal to or greater than 0.5A, and requirements for displaying pictures can be satisfied.

Based on the above, the invention provides a display apparatus, including a reflective display and a front light source module. An illuminating beam emitted by the front light source module illuminates the reflective display from the front of the reflective display, so that the display apparatus can display a picture. The illuminating beam does not need to pass through the entire reflective display to suffer a loss. Therefore, energy consumption of the display apparatus is low, and even though use time of an electronic device using the display apparatus is extended, it is not necessary to frequently replace a battery or to frequently recharge the display apparatus.

Finally, it should be noted that the foregoing embodiments are merely intended to describe the technical solutions of the invention, but not to limit the invention. Although the invention is described in detail with reference to the foregoing embodiments, persons of ordinary skill in the art should understand that they may still make modifications to the technical solutions described in the foregoing embodiments or make equivalent replacements to some or all technical features thereof, without departing from the scope of the technical solutions of the embodiments of the invention.

1. A display apparatus, comprising:
a reflective display; and
a front light source module, provided with a light emitting element adapted to emit an illuminating beam, wherein there is an included angle θ between an optical axis of the light emitting element and a normal line of a display surface of the reflective display, and 0°≤|θ|≤75°, and
the illuminating beam passes through space between the front light source module and the reflective display and is reflected by the reflective display.

2. The display apparatus according to claim 1, wherein the front light source module is capable of moving relative to the reflective display.

3. The display apparatus according to claim 1, wherein the front light source module is pivotally connected to the reflective display.

4. The display apparatus according to claim 3, wherein the front light source module is disposed adjacent to the reflective display and is adapted to rotate toward the reflective display with a first rotation axial line as an axis.

5. The display apparatus according to claim 4, wherein the light emitting element is adapted to rotate with a second rotation axial line as an axis.

6. The display apparatus according to claim 3, wherein the front light source module is adjacently disposed at a first position on the reflective display and is adapted to rotate to a second position located outside the reflective display with a first rotation axial line as an axis.

7. The display apparatus according to claim 1, wherein the front light source module further comprises:
a light path guiding structure, wherein the light emitting element is disposed adjacent to the light path guiding structure and is located between the light path guiding structure and the reflective display, and the light path guiding structure is disposed beside the reflective display.

8. The display apparatus according to claim 1, wherein the front light source module is slidably disposed beside the reflective display.

9. The display apparatus according to claim 8, wherein the front light source module further comprises:
a light path guiding structure, provided with a convex surface, wherein the light emitting element is disposed on the convex surface of the light path guiding structure and is located between the convex surface of the light path guiding structure and the reflective display.

10. The display apparatus according to claim 1, further comprising:
a casing, wherein the reflective display is disposed inside the casing, and the light emitting element is disposed adjacent to the casing.

11. The display apparatus according to claim 1, wherein the front light source module further comprises:
a light path guiding structure, wherein the illuminating beam is reflected by the light path guiding structure to be transmitted toward the reflective display.

12. The display apparatus according to claim 11, wherein the light path guiding structure is provided with a concave surface, and the illuminating beam is reflected by the concave surface to be transmitted toward the reflective display.

13. The display apparatus according to claim 1, wherein an area of the display surface of the reflective display is A, and an area of the reflective display that is covered by the illuminating beam is equal to or greater than 0.7A.

14. The display apparatus according to claim 1, wherein the reflective display is one of a total reflective liquid crystal display and a transflective liquid crystal display.
